(19) United States
(12) Patent Application Publication
(10) Pub. No.: US 2007/0116328 A1
(43) Pub. Date: May 24, 2007

(54) Nudity mask for use in displaying video camera images

(76) Inventors: Sezai Sablak, Lancaster, PA (US); David Katz, Hummelstown, PA (US)

Correspondence Address: BAKER & DANIELS LLP, 300 NORTH MERIDIAN STREET, SUITE 2700, INDIANAPOLIS, IN, 46204, US

(21) Appl. No.: 11/286,685

(22) Filed: Nov. 23, 2005

(51) Int. Cl. G06K 9/00; H04N 7/18; G06K 9/34; G06K 9/03

(52) U.S. Cl. 382/103; 382/309; 382/171; 348/143

(57) ABSTRACT

A surveillance camera system includes a camera that acquires images. A display screen is operably coupled with the camera wherein images captured by the camera are displayable on the display screen. A processing device is operably coupled to the camera and/or the display screen. The processing device outputs a nudity mask for display on the display screen such that the nudity mask obscures at least a portion of a person's skin that is included in the images captured by the camera.

### BACKGROUND OF THE INVENTION

1. Field of the Invention.

The present invention relates to a method of removing unwanted content from a displayed image acquired by a video camera and, more particularly, to a method of masking particular unwanted sections from a displayed image acquired by a video camera.

2. Description of the Related Art

Video surveillance camera systems are found in many locations and may include either fixed cameras that have a fixed field of view and/or adjustable cameras that can pan, tilt and/or zoom to adjust the field of view of the camera. The video output of such cameras is typically communicated to a central location where it is displayed on one of several display screens and where security personnel may monitor the display screens for suspicious activity.

Closed circuit television cameras mounted high up on buildings or on street lamp poles for monitoring traffic or for other security purposes are often fully functional. With the latest low light technology and with powerful zoom lenses, these cameras are capable of capturing scenes in private locations to a much greater extent than most people think possible. Even though people are aware that they may be under video surveillance, the majority of the public is unaware of the sophistication of these cameras and of the wide range of images that these cameras are capable of acquiring. This is especially true of people who live in a downtown area and believe that they are safely out of view in their homes when in fact they are not.

In addition to the violation of unsuspecting peoples' privacy, another problem presented by these cameras is that the scenes of nudity which the cameras enable video screens to display may distract guards from their primary purpose of watching for breaches of security. It is even possible that a guard with prurient interests may redirect such a camera from the premises to be monitored toward scenes of potential nudity, thereby further increasing the chances of a security breach going undetected.

What is needed in the art is a method of inhibiting the display of scenes of nudity that are captured by video surveillance cameras.

### SUMMARY OF THE INVENTION

The present invention provides a surveillance camera system that recognizes human skin and obscures the display of the skin, thereby inhibiting the display of any potential scenes of nudity. The vision system may identify images of nudity by detecting skin-colored regions, extracting very simple features from these regions and making a classification decision. A two-stage skin filtering algorithm using likelihood matrices in hue, saturation, value (HSV) space followed by some local clustering may be used.

The invention comprises, in one form thereof, a surveillance camera system including a camera that acquires images. A display screen is operably coupled with the camera wherein images captured by the camera are displayable on the display screen. A processing device is operably coupled to the camera and/or the display screen. The processing device outputs a nudity mask for display on the display screen such that the nudity mask obscures at least a portion of a person's skin that is included in the images captured by the camera.

The invention comprises, in another form thereof, a method of operating a surveillance camera system, including acquiring images with a camera. Human skin within the acquired images is recognized. The acquired images are displayed on a display screen such that at least a portion of the recognized human skin is obscured in the displayed images.

The invention comprises, in yet another form thereof, a method of operating a surveillance camera system, including acquiring images with a camera. Sections including pixels having color values approximately equal to color values of human skin are identified in the acquired images. Information is removed from the identified sections in the acquired images. The acquired images are displayed after said removing step.

An advantage of the present invention is that it protects the privacy of people within the camera's field of view and lessens the chance of a guard becoming distracted by displayed scenes of nudity.

Another advantage is that the invention may operate automatically and may be used with any security camera.

Yet another advantage is that the invention enables very precise nudity masking, such as pixel-by-pixel.

A further advantage is that the nudity mask may be applied to either non-stationary or stationary images.

Still another advantage is that the invention may be used in conjunction with dynamic zooming.

Still yet another advantage is that the invention does not require any camera calibration.

Another advantage is that the invention may be used to mask any color of skin.

Yet another advantage is that the invention may employ different forms of nudity masks, such as solid, translucent, low-resolution and opaque masks.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic view of a video surveillance system in accordance with the present invention.

FIG. 2 is a schematic view of the processing device of FIG. 1.

FIG. 3 is a schematic view of a portion of the processing device which may be used with an analog video signal.

FIG. 4 is an illustrative histogram of hue and saturation values for human skin.

FIG. 5 illustrates an intersection between a slice of the histogram of FIG. 4 with a fixed saturation value and a histogram of the hue values of a section of an acquired image with the same fixed saturation value.

FIG. 6 is a flow chart illustrating one embodiment of a method of the present invention for applying a nudity mask.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise form disclosed.

### DESCRIPTION OF THE PRESENT INVENTION

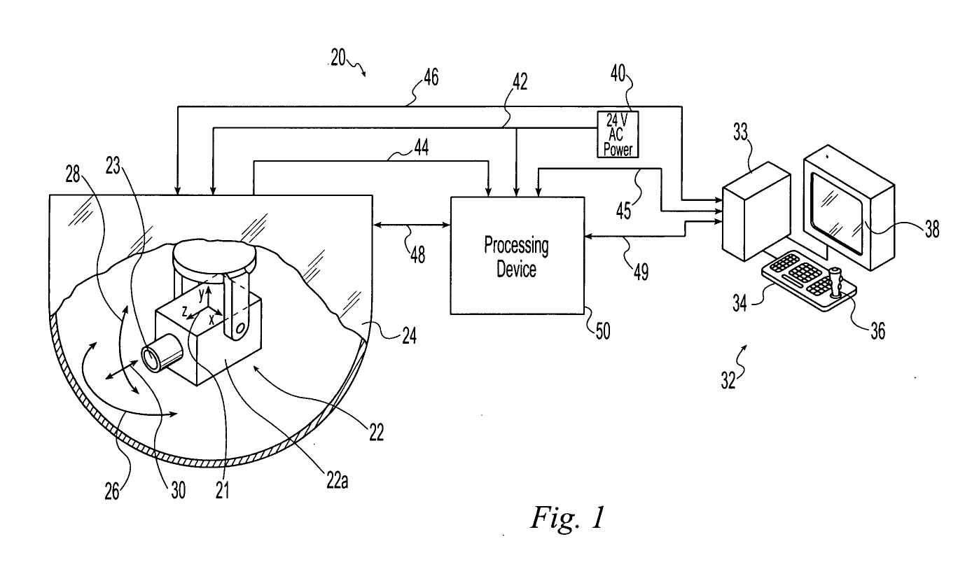

In accordance with the present invention, a video surveillance system 20 is shown in FIG. 1. System 20 includes a camera 22 which is located within a partially spherical enclosure 24. Enclosure 24 may be tinted to allow the camera to acquire images of the environment outside of enclosure 24 and simultaneously prevent individuals in the environment who are being observed by camera 22 from determining the orientation of camera 22. Camera 22 includes motors which provide for the panning, tilting and adjustment of the focal length of camera 22. Panning movement of camera 22 is represented by arrow 26, tilting movement of camera 22 is represented by arrow 28 and the changing of the focal length of the lens 23 of camera 22, i.e., zooming, is represented by arrow 30. As shown with reference to coordinate system 21, panning motion corresponds to movement along the x-axis, tilting motion corresponds to movement along the y-axis and focal length adjustment corresponds to movement along the z-axis. In the illustrated embodiment, camera 22 and enclosure 24 are a Philips AutoDome® Camera Systems brand camera system, such as the G3 Basic AutoDome® camera and enclosure, which are available from Bosch Security Systems, Inc. formerly Philips Communication, Security & Imaging, Inc. having a place of business in Lancaster, Pa. A camera suited for use with the present invention is described by Sergeant et al. in U.S. Pat. No. 5,627,616, entitled Surveillance Camera System, which is hereby incorporated herein by reference.

System 20 also includes a head end unit 32. Head end unit 32 may include a video switcher or a video multiplexer 33. For example, the head end unit may include an Allegiant brand video switcher available from Bosch Security Systems, Inc. formerly Philips Communication, Security & Imaging, Inc. of Lancaster, Pa. such as a LTC 8500 Series Allegiant Video Switcher which provides inputs for up to sixty-four cameras and may also be provided with eight independent keyboards and eight monitors. Head end unit 32 includes a keyboard 34 and joystick 36 for operator or user input. Head end unit 32 also includes a display device in the form of a monitor 38 for viewing by the operator. A 24 volt AC power source 40 is provided to power both camera 22 and a processing device 50. Processing device 50 is operably coupled to both camera 22 and head end unit 32.

Illustrated system 20 is a single camera application, however, the present invention may be used within a larger surveillance system having additional cameras which may be either stationary or moveable cameras or some combination thereof to provide coverage of a larger or more complex surveillance area. One or more VCRs or other form of analog or digital recording device may also be connected to head end unit 32 to provide for the recording of the video images captured by camera 22 and other cameras in the system.

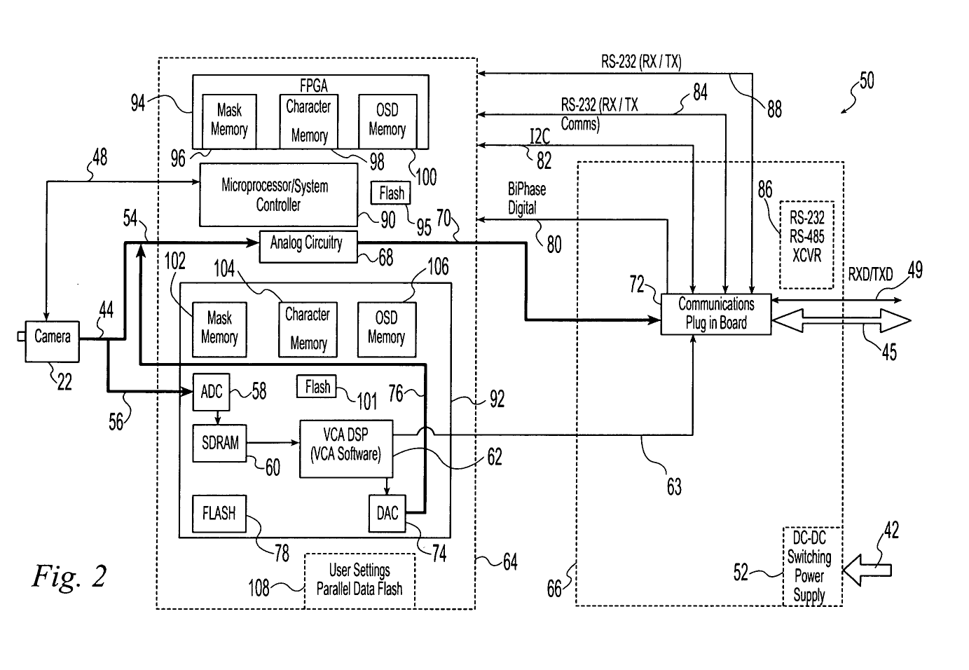

The hardware architecture of processing device 50 is schematically represented in FIG. 2. In the illustrated embodiment, processing device 50 includes a system controller board 64. A power supply/IO section 66 of processing device 50 is illustrated as a separate board in FIG. 2, however, this is done for purposes of clarity and the components of power supply/IO section 66 may be directly mounted to system controller board 64. A power line 42 connects power source 40 to converter 52 in order to provide power to processing device 50. Processing device 50 receives a raw analog video feed from camera 22 via video line 44, and video line 45 is used to communicate video images to head end unit 32. In the illustrated embodiment, video lines 44, 45 are coaxial, 75 ohm, 1 Vp-p and include BNC connectors for engagement with processing device 50. The video images provided by camera 22 can be analog and may conform to either NTSC or PAL standards. Board 72 can be a standard communications board capable of handling biphase signals and including a coaxial message integrated circuit (COMIC) for allowing two-way communication over video links.

Via another analog video line 56, an analog-to-digital converter 58 receives video images from camera 22 and converts the analog video signal to a digital video signal. After the digital video signal is stored in a buffer in the form of SDRAM 60, the digitized video images are passed to video content analysis digital signal processor (VCA DSP) 62. A video stabilization algorithm is performed in VCA DSP 62. Examples of image stabilization systems that may be employed by system 20 are described by Sablak et al. in a U.S. patent application entitled “IMAGE STABILIZATION SYSTEM AND METHOD FOR A VIDEO CAMERA”, filed on the same date as the present application and having a common assignee with the present application, the disclosure of which is hereby incorporated herein by reference. The adjusted display image is sent to digital-to-analog converter 74 where the video signal is converted to an analog signal. The resulting annotated analog video signal is sent via analog video lines 76, 54, analog circuitry 68 and analog video line 70 to communications plug-in board 72, which then sends the signal to head end unit 32 via video line 45.

Processor 62 may be a TIDM 642 multimedia digital signal processor available from Texas Instruments Incorporated of Dallas, Tex. At start up, the programmable media processor 62 loads a bootloader program. The boot program then copies the VCA application code from a memory device such as flash memory 78 to SDRAM 60 for execution. In the illustrated embodiment, flash memory 78 provides four megabytes of memory and SDRAM 60 provides thirty-two megabytes of memory. Because the application code from flash memory 78 is loaded on SDRAM 60 upon start up, SDRAM 60 is left with approximately twenty-eight megabytes of memory for video frame storage and other software applications.

In the embodiment shown in FIG. 2, components located on system controller board 64 are connected to communications plug-in board 72 via a high speed serial communications bus 63, biphase digital data bus 80, an 12C data bus 82, and RS-232 data buses 84, 88. An RS-232/RS-485 compatible transceiver 86 may also be provided for communication purposes. Coaxial line 45 provides communication between processing device 50 and head end unit 32 via communications plug in board 72. Various additional lines, such as line 49, which can be in the form of an RS-232 debug data bus, may also be used to communicate signals from head end unit 32 to processing device 50. The signals communicated by these lines, e.g., lines 45 and 49, can include signals that can be modified by processing device 50 before being sent to camera 22. Such signals may be sent to camera 22 via line 48 in communication with a microcontroller 90. In the illustrated embodiment, microcontroller 90 is a H8S/2378 controller commercially available from Renesas Technology America, Inc. having a place of business in San Jose, Calif.

Microcontroller 90 operates system controller software and is also in communication with VCA components 92. Although not shown, conductive traces and through-hole vias lined with conductive material are used provide electrical communication between the various components mounted on the printed circuit boards depicted in FIG. 2. Thus, VCA components such as VCA DSP 62 can send signals to camera 22 via microcontroller 90 and line 48. It is also possible for line 46 to be used to communicate signals directly to camera 22 from head end unit 32 without communicating the signals through processing device 50. Various alternative communication links between processing device 50 and camera 22 and head unit 32 could also be employed with the present invention.

System controller board 64 also includes a field programmable gate array (FPGA) 94 including three memory devices, i.e., a mask memory 96, a character memory 98, and an on-screen display (OSD) memory 100. In the illustrated embodiment, FPGA 94 may be a FPGA commercially available from Xilinx, Inc. having a place of business in San Jose, Calif. and sold under the name Spartan 3. In the illustrated embodiment, mask memory 96 is a 4096×16 dual port random access memory module, character memory 98 is a 4096×16 dual port random access memory module, and OSD memory 100 is a 1024×16 dual port random access memory module. Similarly, VCA components 92 includes a mask memory 102, a character memory 104, and an on-screen display (OSD) memory 106 which may also be dual port random access memory modules. These components may be used to mask various portions of the image displayed on-screen 38 or to generate textual displays for screen 38. More specifically, this configuration of processing device 50 enables the processor to apply nudity masks, privacy masks, virtual masks, and on-screen displays to either an analog video signal or a digital video signal.

If it is desired to apply the nudity masks and on-screen displays to a digital image signal, memories 102, 104 and 106 may be used, and the processing necessary to calculate the position of the nudity masks and on-screen displays would take place in processor 62. If the nudity masks and on-screen displays are to be applied to an analog video signal, memories 96, 98, and 100 would be used and the processing necessary calculate the position of the nudity masks and on-screen displays would take place in microprocessor 90. The inclusion of VCA components 92, including memories 102, 104, 106 and processor 62, in processing device 50 facilitates video content analysis, such as for recognizing human skin in the image. Alternative embodiments of processing device 50 which do not provide the same video content analysis capability, however, may be provided without VCA components 92 to thereby reduce costs. In such an embodiment, processing device 50 would still be capable of applying nudity masks, privacy masks, virtual masks, and on-screen displays to an analog video signal through the use of microprocessor 90 and field programmable array (FPGA) 94 with its memories 96, 98, and 100.

Processing device 50 also includes rewritable flash memory devices 95, 101. Flash memory 95 is used to store data including character maps that are written to memories 98 and 100 upon startup of the system. Similarly, flash memory 101 is used to store data including character maps that are written to memories 104 and 106 upon startup of the system. By storing the character map on a rewritable memory device, e.g., either flash memory 95, 101, instead of a read-only memory, the character map may be relatively easily upgraded at a later date if desired by simply overwriting or supplementing the character map stored on the flash memory. System controller board 64 also includes a parallel data flash memory 108 for storage of user settings including user-defined privacy masks wherein data corresponding to the user-defined privacy masks may be written to memories 96 and/or 102 upon startup of the system.

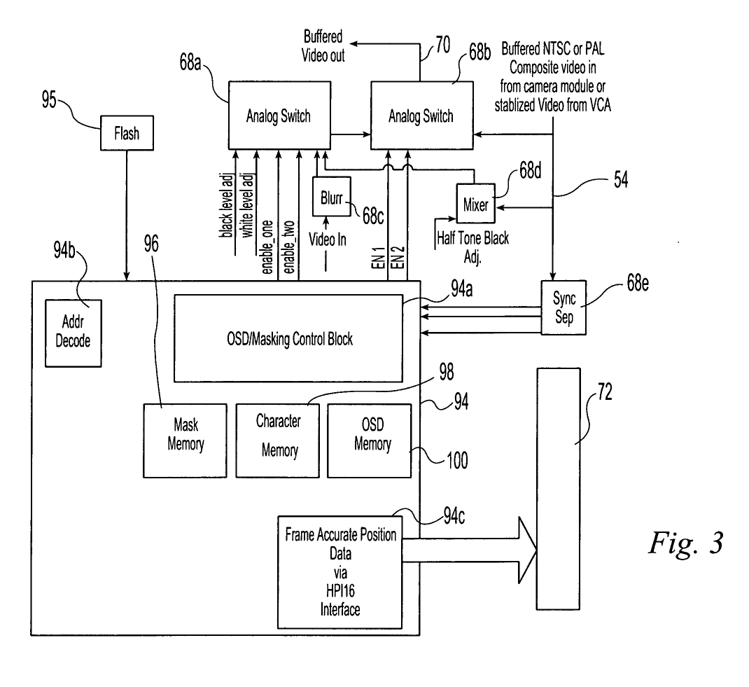

FIG. 3 provides a more detailed schematic illustration of FPGA 94 and analog circuitry 68 than that shown in FIG. 2. As seen in FIG. 3, in addition to mask memory 96, character memory 98 and OSD memory 100, FPGA 94 also includes an OSD/Masking control block 94a, an address decoder 94b, and an optional host-port interface HPI16 94c for communicating frame accurate position data. The HPI16 interface is used when the privacy mask and informational displays, e.g., individual text characters, are to be merged with a digital video image using VCA components 92.

As also seen in FIG. 3, analog circuitry (shown in a more simplified manner and labeled 68 in FIG. 2) includes a first analog switch 68a, a second analog switch 68b, a filter 68c, an analog multiplexer 68d, and a video sync separator 68e. A “clean” analog video signal, i.e., although the image may be stabilized, the video signal includes substantially all of the image captured by camera 22 without any substantive modification to the content of the image, is conveyed by line 54 to the second analog switch 68b, mixer 68c and sync separator 68e. An analog video signal is conveyed from mixer 68c to first analog switch 68a. Mixer 68c also includes a half tone black adjustment whereby portions of the video signal may be modified with a grey tone. Sync separator 68e extracts timing information from the video signal which is then communicated to FPGA 94. A clean analog video signal, such as from FPGA 94 or line 54, is also received by filter 68c. Passing the analog video signal through filter 68c blurs the image and the blurred image is communicated to analog switch 68a. Analog switch 68a also has input lines which correspond to black and white inputs. Two enable lines provide communication between analog switch 68a and FPGA 94. The two enable lines allow FPGA 94 to control which input signal received by analog switch 68a is output to analog switch 68b. As can also be seen in FIG. 3, second analog switch 68b includes two input lines, one corresponding to a “clean” analog video signal from line 54 and the output of analog switch 68a. Two enable lines provide communication between analog switch 68b and FPGA 94 whereby FPGA 94 controls which signal input into analog switch 68b is output to line 70 and subsequently displayed on display screen 38.

Each individual image, or frame, of the video sequence captured by camera 22 is comprised of pixels arranged in a series of rows and the individual pixels of each image are serially communicated through analog circuitry 68 to display screen 38. When analog switch 68b communicates clean video signals to line 70 from line 54, the pixels generated from such a signal will generate on display screen 38 a clear and accurate depiction of a corresponding portion of the image captured by camera 22. To blur a portion of the image displayed on-screen 38 (and thereby generate a nudity mask or privacy mask or indicate the location of a virtual mask), analog switch 68a communicates a blurred image signal, corresponding to the signal received from filter 68c, to analog switch 68b. Switch 68b then communicates this blurred image to line 70 for the pixels used to generate the selected portion of the image that corresponds to the nudity mask, privacy mask or virtual mask. If a grey tone nudity mask, privacy mask or virtual mask is desired, the input signal from mixer 68d (instead of the blurred image signal from filter 68c) can be communicated through switches 68a and 68b and line 70 to display screen 38 for the selected portion of the image. To generate on-screen displays, e.g., black text on a white background, analog switch 68a communicates the appropriate signal, either black or white, for individual pixels to generate the desired text and background to analog switch 68b which then communicates the signal to display screen 38 through line 70 for the appropriate pixels. Thus, by controlling switches 68a and 68b, FPGA 94 generates nudity masks, privacy masks, virtual masks, and informational displays on display screen 38 in a manner that can be used with an analog video signal. In other words, pixels corresponding to nudity masks, privacy masks, virtual masks, or informational displays are merged with the image captured by camera 22 by the action of switches 68a and 68b.

In the illustrated embodiment, commands may be input by a human operator at head end unit 32 and conveyed to processing device 50 via one of the various lines, e.g., lines 45, 49, providing communication between head end unit 32 and processing device 50 which also convey other serial communications between head end unit 32 and processing device 50. In the illustrated embodiment, processing device 50 is provided with a sheet metal housing and mounted proximate camera 22. Processing device 50 may also be mounted employing alternative methods and at alternative locations. Alternative hardware architecture may also be employed with processing device 50. It is also noted that by providing processing device 50 with a sheet metal housing, its mounting on or near a PTZ (pan, tilt, zoom) camera is facilitated and system 20 may thereby provide a stand alone embedded platform which does not require a personal computer-based system.

The provision of a stand-alone platform as exemplified by processing device 50 also allows the present invention to be utilized with a video camera that outputs unaltered video images, i.e., a “clean” video signal that has not been modified. After being output from the camera assembly, i.e., those components of the system within camera housing 22a, the “clean” video may then have a nudity mask and on-screen displays applied to it by the stand-alone platform. It is also possible, however, for processing device 50 to be mounted within housing 22a of the camera assembly.

The present invention may generally include acquiring images with camera 22, and identifying, in the acquired images, sections including pixels having color values approximately equal to color values of human skin. Information may be removed from the identified sections such that segments of human skin in the acquired images are less recognizable to a human observer. In general, the content or color values of the pixels in the identified image sections may be altered to make the human skin in the images more difficult for the viewer to discern. In one embodiment, removing information from the identified sections includes outputting a nudity mask that obscures at least a portion of a person's skin that is included in the acquired images. The removal of the information may be dependent upon a size, shape, and/or orientation of the identified sections. After the undesired information is removed from the acquired images, the images may be displayed.

In one embodiment, the present invention identifies human skin based upon clusters or sections of commonly skin-colored pixels in the acquired images. In one particular embodiment, the image is analyzed in the hue, saturation, and value (HSV) color space, which may be derived from the red, green blue (RGB) color space. The present invention may employ a direct pixel-based segmentation technique in which the HSV color space is partitioned into a skin color region and a non-skin color region. The pixels in which the hue, saturation and value (brightness) values are all within the skin color region of the HSV color space may be recognized as skin.

The segmentation of a color image may include classifying the pixels within the image into a set of clusters each having a uniform color characteristic. The color clusters that correspond to the colors of human skin may be detected and isolated.

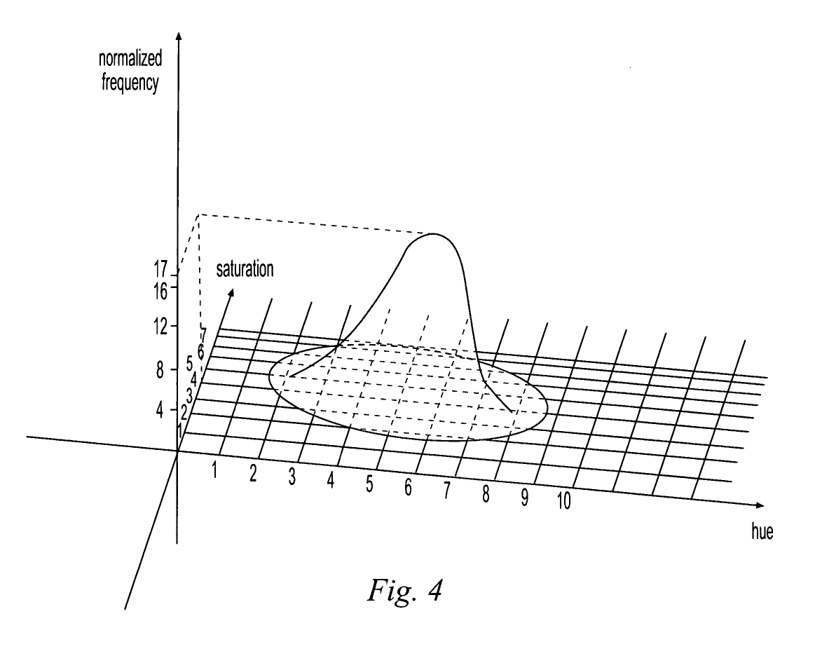

Color values that correspond to the colors of human skin may be empirically measured, and the normalized frequency of each of these color values may be stored in a lookup table. In order to achieve intensity invariance, and to reduce the amount of computation, only the chromacity (i.e., hue and saturation) color values may be considered, to the exclusion of brightness. Thus, a two-dimensional histogram of the combinations of hue and saturation color values that correspond to human skin may be created, as shown in FIG. 4. The values of the histogram of FIG. 4 have been chosen for purposes of ease of illustration, and are not indicative of any actual skin color values. The values of the histogram of FIG. 4 may have a normal distribution in both the hue direction and in the saturation direction, with a peak normalized frequency at approximately hue=5 and saturation=4.

Generally, pixels in the image that color values approximately equal to color values of human skin are recognized. More specifically, in order to identify a section of an acquired image that may include human skin, the processor may first look for pixels in the image that have color values corresponding to relatively high normalized frequencies in the histogram of FIG. 4. For example, the processor may initially look for pixels having color values of hue=5 and saturation=4. A single pixel having color values in the skin color range is not a good indication that the pixel is part of an image of skin, however, because an image may contain many isolated pixels that have the same color as skin but are associated with the background. Another problem is that for any particular image of human skin, the distribution of color values is not guaranteed to closely correspond to the FIG. 4 histogram of the range of skin colors. However, a legitimate assumption may be that skin regions are of reasonable area compared to the total image area and contain a locally maximum likelihood value, such as hue=5 and saturation=4. The present invention may employ a region-growing algorithm that uses as its seed points likelihood local maxima above a certain threshold. The regions may be grown out to a lower likelihood threshold. The putative skin regions may correspond to the largest area granules with an underlying likelihood above a lower likelihood threshold.

Thus, after identifying an initial seed pixel having color values of hue=5 and saturation=4, the processor may then look at the color values of the adjacent or surrounding pixels and determine whether those color values correspond to relatively high normalized frequencies in the histogram of FIG. 4. As a simple example, the processor may determine whether a majority of the adjacent pixels have hue values between threshold values of 4 and 6 and saturation values between threshold values of 3 and 5. If a majority of the adjacent pixels do in fact have color values within that range, it may be more probable that the pixels are within a section of the image that includes human skin. The processor may then examine the color values of the next ring of pixels that surround the pixels that are adjacent the initial pixel. Because of the increased confidence that the pixels are part of a skin section of the image, the range of the threshold color values may be expanded. For example, the processor may determine whether the color values of the next ring of pixels have hue values between threshold values of 3 and 7 and saturation values between threshold values of 2 and 6. If a majority, or some predetermined percentage, of the ring of pixels do in fact have color values within that range, it may be still more probable that the pixels are within a section of the image that includes human skin.

The above-described process may continue so long as some percentage of the examined color values of the pixels are within the threshold range of skin color values. After a boundary of the potentially skin colored image section has been found, that is, after a group of pixels having color values that are outside the threshold range of skin color values has been found, examination of the color values of additional pixels on the opposite side of the of the potentially skin colored image section may continue until all of the boundaries of the potentially skin colored image section have been located in the image.

Within the potentially skin colored image section, any small pockets of pixels having color values that are outside the threshold range of skin color values may have their color values changed to color values that are inside the threshold range of skin color values. This process may be referred to as “flood filling.”

After the potentially skin colored image section, or a portion of the potentially skin colored image section, has been identified, the color values of the associated pixels may be examined as a group in order to make a decision as to whether the image section, or portion of image section, is sufficiently skin colored for a nudity mask to be applied thereto. To this end, a histogram of the normalized frequency of the color values of the identified image pixels may be compared to the known skin color histogram of FIG. 4. The greater the similarity between the two histograms, the greater the probability that the image section, or portion of the image section, includes human skin. That is, human skin, or segments thereof, may be recognized in the acquired images dependent upon the comparison of the color values. In one embodiment, a measure of the similarity s between the two histograms Hₛₖᵢₙ and H_{image} may be defined as the intersection of the two histograms:

$$s ( {H}_{skin} , {H}_{image} ) = {\sum }_{i , j}^{n} min \vert {H}_{skin} ( i , j ) , {H}_{image} ( i , j ) \vert$$

The two histograms Hₛₖᵢₙ and H_{image} may be normalized such that 0≦s≦1. The term min|Hₛₖᵢₙ(i, j), H_{image}(i, j)| in the above equation may be thought of as the lesser of the two histogram values at the particular values of hue (i) and saturation (j). Thus, because the histograms are normalized, the greater the summation of the lesser histogram values (i.e., the greater the value of s), the greater the similarity between the two histograms and the more likely that the image pixels are part of an image of human skin.

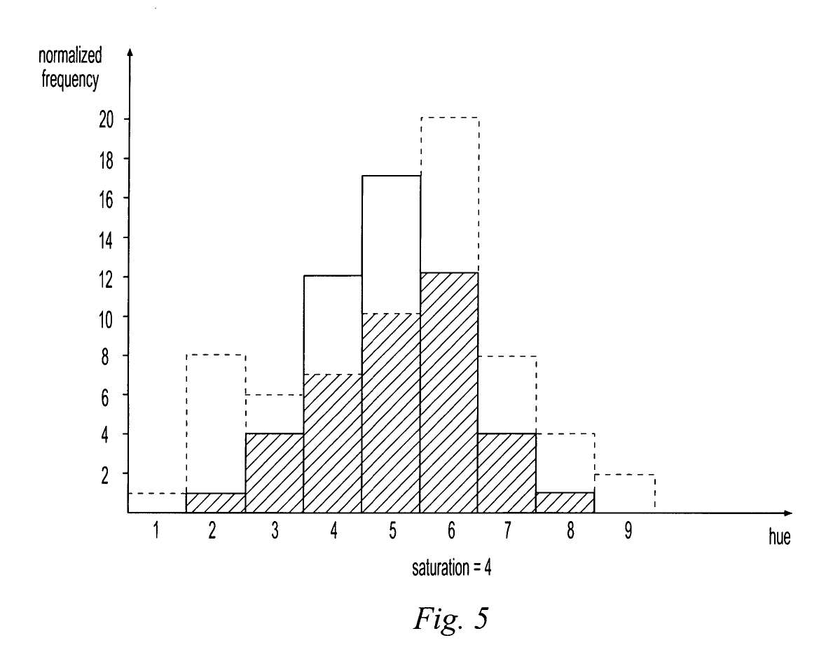

A “slice” through illustrative overlapping histograms is shown in FIG. 5, with saturation set to a value of 4. The values of the histogram of FIG. 4 as a function of hue with saturation set to a value of 4 are indicated in FIG. 5 in solid lines. Illustrative histogram values of an exemplary image section being analyzed are indicated in FIG. 5 in dashed lines. For example, at hue=7, the histogram of known skin color values has a normalized frequency value of 4, and the histogram of the color values of the exemplary image section has a normalized frequency value of 8. The intersection between the two histograms, i.e., the lesser of the two histograms at each value of hue, is indicated in cross hatching. It is the summation of such intersections for each value of saturation that may be used as a measure of similarity of the two histograms, and thus to decide whether the image section of interest is skin colored.

Having determined that a section of the image is skin colored, the processor may then further analyze other features of the section of the image to determine whether they are consistent with the existence of nudity in the image. More particularly, the processor may determine whether the size (area), shape or orientation of the skin colored image section is such that there is more than a threshold level of probability that the skin colored image section does indeed include some nudity. The nudity mask may be output dependent upon this determination. The recognition of human skin within the acquired images may be dependent upon the size, shape, and/or orientation of an image section that has color values approximately equal to color values of human skin.

Before a nudity mask is applied, it may be determined whether the skin colored image section is of sufficient size such that it would present a privacy concern or a source of distraction for the viewer. This threshold size of the skin colored image section for applying a nudity mask may be expressed in terms of number of pixels, displayed image size in length and/or width, or as a percentage of the total displayed image.

A partially clothed person may have several discrete or separate segments of exposed skin. For example, a person wearing only shorts may have two exposed legs and a third segment including the torso, arms and head. Several such segments in close proximity to one another may be considered to be one continuous “blob” of skin in one embodiment of the invention. If there is more than one person in the image, there may also be more than one corresponding “blob” in the image. One of the features of the section of the image that may be considered by the processor is the size of the blob, i.e., its area. Other features of the image section may be derived by first finding an ellipse that best approximates or fits the size and shape of the blob. The use of an ellipse may be advantageous because the shape of the human body approximates an ellipse. Features of the image section that may be used by the processor in determining the presence of nudity may include, for example, an x-centroid and/or y-centroid of the blob ellipse; the length of the major axis and/or minor axis of the blob ellipse; the eccentricity of the ellipse; the orientation of the ellipse; the area of a convex hull fitted to the blob; and the diameter of a circle that has the same area as the blob.

Some of the above-described image features may be more important than others in determining the existence of nudity. Thus, the various image features may be ranked, and the decision whether to apply a nudity mask may be dependent upon the rankings of the image features. The features may be ranked using the mutual information of the class given the single feature. This process provides a subset of features that are used in one embodiment to make the nudity masking determination: the area of the largest blob in the image; the blob's centroid coordinates; the major and minor lengths of the fitted ellipse; and the orientation of the ellipse. These features may be evaluated using a k-nearest neighbor classifier algorithm, for example.

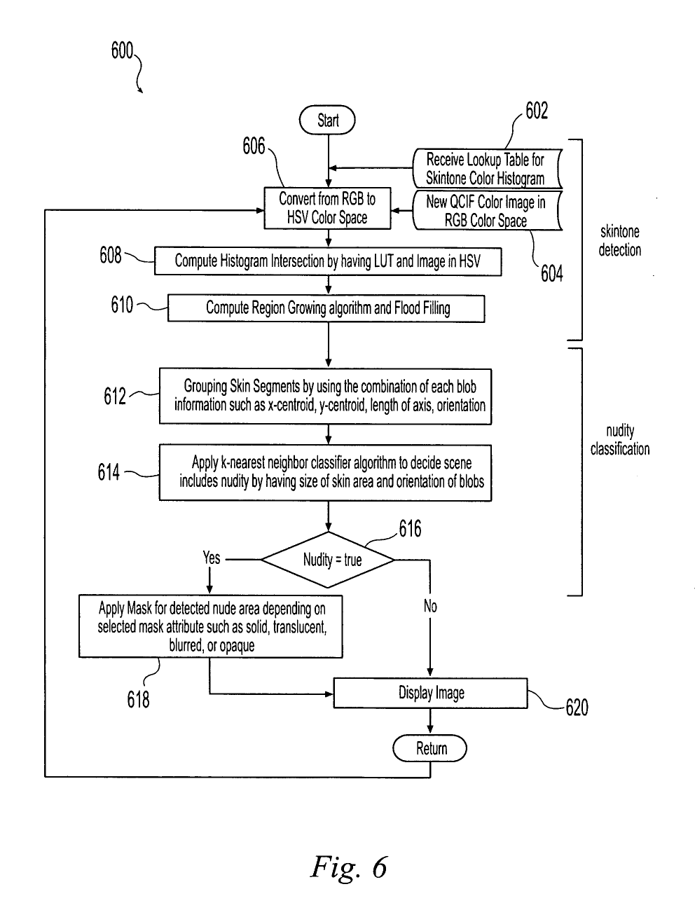

FIG. 6 provides a flowchart indicating one embodiment of a method 600 by which nudity masks are displayed on display screen 38 during normal operation of the surveillance camera system 20. In a first step 602, a lookup table including normalized frequency values for each combination of hue and saturation values in the skintone color histogram may be downloaded into processing device 50. In step 604, a new quarter common intermediate format (QCIF) color image in RGB color space is acquired by camera 22. In step 606, the color image acquired by camera 22 is converted from RGB to HSV color space. It is also possible that the skintone color histogram is downloaded into the processing device in RGB color space, in which case it too may be converted to HSV color space in step 606. In step 608, a histogram of a section of the acquired image, or of the entire acquired image, is computed and compared to the known histogram of skin colors in order to determine the intersection of the histograms. If the histogram is computed for only a section of the image, then additional histograms for each of the other image sections may be computed and compared to the known histogram of skin colors in order to find additional intersections. Thus, it may determined, either for the image as a whole or for each image section individually, whether the image likely includes skin. In a final step 610 of the skintone detection process, the region of skin color pixels in the acquired image is “grown” by examining small groups of pixels surrounding a core of skin colored pixels, as described above, until a complete set of boundaries of the skin colored segments in the image are located. Any small pockets of pixels within the boundaries that are not skin colored may be converted into skin colored pixels in the flood filling process. In the embodiment of method 600, the computation of the histogram intersection occurs before the computation of the region growing algorithm. However, it is also possible for the order of these two steps to be reversed.

In a first step 612 of the nudity classification process, segments of skin that may belong to the same person in the image are grouped together into a blob. For example, three separate segments of skin may include two legs and a torso, respectively, and may be grouped together into a blob. Various features of separate image sections, each corresponding to one of the skin segments, may be analyzed to determine whether a combination of one or more of the image sections is consistent with at least a portion of a human body. Such features may include the x-centroid, y-centroid, length of elliptical axis, and orientation of the individual image sections, for example.

Alternatively, or additionally, a number of blobs may be formed by various combinations of the image sections, and the features of these blobs may be analyzed individually to thereby determine whether the features of that particular combination of image sections are indicative of, or consistent with, a human body. Such features may include the x-centroid, y-centroid, length of elliptical axis, and orientation of the individual blobs, for example.

In a next step 614, a k-nearest neighbor classifier algorithm may be applied to decide whether the image includes an objectionable level of nudity based upon the above-described image features, which may include the skin area and orientation of one or more blobs. If it is decided in step 616 that there is a sufficient amount of exposed skin in the image, then the program proceeds to step 618 where the nudity mask is applied to the detected section of the image that includes exposed skin to thereby obscure at least a portion of the skin.

In one embodiment, substantially all of the person's skin that is included and recognized in the images captured by the camera is obscured. In another embodiment, the nudity mask may obscure a continuous section of the image that includes a plurality of separate segments of the person's skin. The continuous section may be in the form of a blob that is created by joining together the separate segments of the person's exposed skin.

Different types of obscuring infill may be used with the nudity mask. For example, the nudity mask may employ a solid infill, a translucent infill, a blurred infill, or an opaque infill. A solid mask infill may take the form of a solid color infill, such as a homogenous gray or white infill, that obscures the video image within the mask by completely blocking that section of the video image that corresponds to the nudity mask. A translucent infill may be formed by reducing the resolution of the video image contained within the nudity mask area to thereby obscure the video image within the nudity mask without blocking the entirety of the video image within the mask. For example, for a digital video signal, the area within the nudity mask may be broken down into blocks containing a number of individual pixels. The values of the individual pixels comprising each block are then averaged and that average value is used to color the entire block. For an analog video signal, the signal corresponding to the area within the mask may be filtered to provide a reduced resolution. These methods of reducing the resolution of a selected portion of a video image are well known to those having ordinary skill in the art.

These methods of obscuring the image may be desirable in some situations where it is preferable to reduce the resolution of the video image within the nudity mask without entirely blocking that portion of the image. For example, if the human subject of the nudity mask is also suspected of committing a breach of security, by using a translucent nudity mask, the details of the image corresponding to the person's exposed skin may be sufficiently obscured by the reduction in resolution to provide the desired privacy while still allowing security personnel to perceive the general movements of the individual to whom the nudity mask is applied.

After the nudity mask is applied in step 618, the image may be displayed on screen 38 in step 620, and operation then returns to step 606 to begin processing of the next acquired image. If it is determined in step 616 that there is not a sufficient level of nudity to apply a nudity mask, then the image is displayed in step 620, and operation returns to step 606 to begin processing of the next acquired image.

Processing device 50 may perform several functions in addition to the provision of nudity masking, privacy masking, virtual masking, and on-screen displays. One such function may be an automated tracking function. For example, processing device 50 may identify moving target objects in the field of view (FOV) of the camera and then generate control signals which adjust the pan, tilt and zoom settings of the camera to track the target object and maintain the target object within the FOV of the camera. An example of an automated tracking system that may be employed by system 20 is described by Sablak et al. in U.S. patent application Ser. No. 10/306,509 filed on Nov. 27, 2002 entitled “VIDEO TRACKING SYSTEM AND METHOD” the disclosure of which is hereby incorporated herein by reference. It is possible for automatic tracking to be applied to the same human subject to which the nudity masking of the present invention is applied.

While this invention has been described as having an exemplary design, the present invention may be further modified within the spirit and scope of this disclosure. This application is therefore intended to cover any variations, uses, or adaptations of the invention using its general principles.

What is claimed is:

1. A surveillance camera system comprising:
a camera configured to acquire images;
a display screen operably coupled with said camera wherein images captured by said camera are displayable on said display screen; and
a processing device operably coupled to at least one of said camera and said display screen, said processing device configured to output a nudity mask for display on said display screen such that the nudity mask obscures at least a portion of a person's skin that is included in the images captured by said camera.

2. The system of claim 1 wherein the nudity mask obscures substantially all of the person's skin that is included in the images captured by said camera.

3. The system of claim 2 wherein the nudity mask obscures a continuous section of an image that includes a plurality of separate segments of the person's skin.

4. The system of claim 1 wherein said processing device is further configured to compare color values of pixels in the acquired images with color values of human skin.

5. The system of claim 4 wherein said processing device is further configured to recognize segments of human skin in the acquired images, said recognizing being dependent upon the comparison of the color values.

6. The system of claim 5 wherein the processing device is further configured to output the nudity mask dependent upon at least one of a size, shape and orientation of a section of an image that includes the person's skin.

7. The system of claim 6 wherein the processing device is further configured to output the nudity mask dependent upon rankings of a plurality of image features, the image features including at least one of the size, shape and orientation of the section of the image that includes the person's skin.

8. A method of operating a surveillance camera system, said method comprising:
acquiring images with a camera;
recognizing human skin within the acquired images; and
displaying the acquired images on a display screen such that at least a portion of the recognized human skin is obscured in the displayed images.

9. The method of claim 8 wherein substantially all of the recognized human skin is obscured in the displayed images.

10. The method of claim 9 wherein a continuous section that includes a plurality of separate segments of the recognized human skin is obscured in the displayed images.

11. The method of claim 8 wherein said recognizing step includes comparing color values of pixels in the acquired images with color values of human skin.

12. The method of claim 11 wherein said recognizing step includes recognizing a plurality of segments of human skin in the acquired images.

13. The method of claim 12 wherein said recognizing step is dependent upon at least one of a size, shape and orientation of a section of an image wherein the section has color values approximately equal to color values of human skin.

14. The method of claim 13 comprising the further step of ranking a plurality of image features, the image features including at least one of the size, shape and orientation of the section of the image that has color values approximately equal to color values of human skin, said recognizing step being dependent upon said ranking step.

15. A method of operating a surveillance camera system, said method comprising:
acquiring images with a camera;
identifying, in the acquired images, sections including pixels having color values approximately equal to color values of human skin;
removing information from the identified sections in the acquired images; and
displaying the acquired images after said removing step.

16. The method of claim 15 comprising the further step of determining at least one of a size, shape and orientation of the identified sections, said removing step being dependent upon said determining step.

17. The method of claim 16 comprising the further step of ranking a plurality of image features, the image features including at least one of the size, shape and orientation of the identified sections, said removing step being dependent upon said ranking step.

18. The method of claim 15 wherein said removing step is performed such that segments of human skin in the acquired images are less recognizable to a human observer.

19. The method of claim 15 wherein said removing step includes outputting a nudity mask that obscures at least a portion of a person's skin that is included in the acquired images.

20. The method of claim 15 wherein the color values include hue and saturation.
